(19) United States
(12) Patent Application Publication
(10) Pub. No.: US 2024/0317617 A1
(43) Pub. Date: Sep. 26, 2024

(54) METHOD FOR PHYSICAL TREATMENT OF LIQUID OR GASEOUS MEDIA AND DEVICE FOR PHYSICAL TREATMENT OF LIQUID OR GASEOUS MEDIA

(71) Applicant: BLUE BOSON INNOVATION SE, Bratislava (SK)

(72) Inventors: Miroslav DANEK, Bratislava (SK); Robert ZAGOZDZON, Bratislava (SK)

(73) Assignee: BLUE BOSON INNOVATION SE, Bratislava (SK)

(21) Appl. No.: 18/574,125

(22) PCT Filed: Jun. 15, 2022
(86) PCT No.: PCT/SK2022/050007

§ 371 Date: Dec. 26, 2023

(30) Foreign Application Priority Data
Jun. 30, 2021 (SK) PP 50037-2021

(51) Int. Cl. C02F 1/48; C02F 1/00; C10L 3/08

(52) U.S. Cl. CPC C02F 1/487; C02F 1/008; C10L 3/08; C02F 2201/486; C02F 2301/026; C02F 2303/22

(57) ABSTRACT

A method for physical treatment of liquid and gaseous media (15) is provided by means of electromagnetic emission with a variable frequency of emission which is in the form of electromagnetic pulses and is emitted into the flowing medium (15) from a space inside the medium (15). The electromagnetic emission with the specific frequency is emitted into the medium (15) through an interface made of a silicon-based material and passes through the medium. A difference of the energy of the generated electromagnetic emission and the energy of the electromagnetic emission passed through the medium (15) is determined, and based on the determined difference of the said energies, the specific frequency of the generated electromagnetic emission is adjusted to increase the difference of the said energies and to achieve in principle the maximum difference of the energies, thus achieving synchronisation of the frequency of the electromagnetic emission with a precession frequency of protons in the medium (15) and absorption of the energy of the electromagnetic emission by the medium (15). Furthermore, a device for the implementation of the aforementioned method is provided.

### TECHNICAL FIELD

The invention relates to a method for physical treatment of liquid and gaseous media by means of electromagnetic emission with a variable frequency of emission, which is emitted into a flowing medium from a space inside the medium. The invention also relates to a device for physical treatment of liquid and gaseous media according to the said method.

### BACKGROUND

The current technologies for treating liquid or gaseous media are defined by energy bonds within and among molecules. Decisive properties of the medium, such as fluidity, electrical conductivity, surface tension, etc., depend on them.

The essence of the physical treatment of water is a disruption of bonds between scale-forming substances and water molecules, which is achieved e.g. by the action of an electromagnetic field. The effects of electromagnetic water treatment on limiting scale formation have long been known. Several devices and methods have been described in the prior art for the treatment of liquids, especially water, by electromagnetic emission.

For example, EP 1941216 describes a device for physical heat treatment of liquid media, wherein the hydrodynamically pretreated medium is treated with a system of electrochemical potentials as well as RC AC electromagnetic signals in a polar and/or ionic manner at one or multiple flow of the media through the device. The device contains a positive electrode, preferably made of Cu, C etc. and negative electrodes, preferably made of stainless steel, Fe, Al etc. The presented electromagnetic signal frequency is in the range from 150 to 450 MHZ, preferably 300 MHz with a power of 0.5 W. In general, frequency ranges from 30 MHz to 5 GHz with a power from 0.1 to 3 W are possible.

EP 2704822 describes a method for physical treatment and/or heating of media, in particular liquids, in which the medium is subjected to ionisation and/or polarisation and at the same time to electromagnetic action, wherein the treated medium is supplemented by laser action as another type of energy, which is located either directly in the body or outside it. In this method, the strength bonds in the molecule or between the molecules are weakened, which results in a change in the physical and/or chemical properties of the medium. The device contains both a positive and a negative electrode. The range of the electromagnetic signal is between 100 and 500 MHz and the electrode has a power of 0.1 to 100 W.

International patent application WO/2017/018944 describes a water treatment method and system in a water system to control one or more parameters such as scale, corrosion, bacteria, and algae. In particular, the invention relates to methods and systems for applying a superimposed time-varying frequency electromagnetic wave comprising both AC and DC components in a pulsating manner to water in the water system, such as cooling water systems, cooling towers, boiler systems, and water accumulation systems. The device uses the frequency of a DC pulsating ion wave with a frequency of 1/100 to 1000 Hz.

U.S. Pat. No. 4,427,544 describes a magneto-electrochemical water treatment reactor, which is located in a non-magnetic piping with an inlet and outlet. There is a DC power supply on the outside of the piping. There is a rotating turbine inside, which is placed on ferromagnetic rods that are housed in the piping. The rotating turbine produces an electric current which affects the formation of calcium in the piping and forms a protective layer against the deposition of incrustations on the energy equipment and heat exchangers.

The US 2007/0029261 application describes a method and a device for water treatment by means of electromagnetic waves for the purpose of de-calcifying. It is a part of the piping with an electromagnetic induction winding, which is connected to a source of electromagnetic signal. An electromagnetic field is generated inside the piping.

DE 888537 describes a method for separating of solids from solutions in order to prevent the formation of deposits on heating and cooling elements in cooperation with the anode and the cathode. This technology is implemented by the effect of magnets having magnetic fields, whether unidirectional or alternating, that are formed or are being formed by a permanent magnet. In an alternative embodiment, the effect is complemented by a high frequency field.

GB 2 433 267 describes a device with electrostatic, electromagnetic and induction fields. It is an electrostatic reduction device with a combined electromagnetic generator connected to a winding. The winding is formed on the outside around the entire circumference of the vessel, in which the reactant is located. The AC generator is connected to an AC electrode in a vessel. The AC generator is connected to the bottom of the vessel and the reactant shows both liquid and solid states of the assembly.

The above devices use ionising emission having sufficient energy to break chemical bonds and form ions, and non-ionising emission, for their action.

A disadvantage of the prior art methods and devices is that they are not universal for a large number of liquid and gaseous media and their physical treatments. Where they use electromagnetic emission, they use only its limited frequency range, and the frequency of electromagnetic emission is often set empirically. When using both ionising and non-ionising emission, each type of emission is generated by a technologically separate part of the device. These devices then require more space and the method for media treatment is therefore more complicated due to the presence of several devices.

Other disadvantages of the prior art solutions for the treatment of a flowing medium consist in an implementation of the medium treatment technology through complex bypasses. If the device is installed e.g. in the piping, then the size of the device will be limited by the size of the piping. This limits the size of the water treatment device and thus the maximum flow through this device. The installation of the device in the piping also limits the size of the piping flow cross-section, and thus reduces the size of the maximum flow of the medium through the piping.

Another disadvantage of the prior art is that not all of the medium in the piping flows through the water treatment device, but only a part of the medium. As a result, only a part of the medium from the total flown-through medium in the piping is treated.

The objective of the present invention is to design the treatment of liquid and gaseous media using a method allowing the generation and use of both non-ionising and ionising emission, wherein the setting of optimal electromagnetic emission parameters will be automatic, wherein the treatment method will be applicable to a wide range of media and physical properties of media, wherein this method will be able feasible using a device, which is space-saving, whose placement e.g. into the piping does not reduce the flow rate through the piping, and which is able to treat the properties of liquid and gaseous media in the entire volume flown through the piping. Furthermore, the objective of the invention is to provide a device enabling easy installation of the device in existing pipings and tanks, which is not limited by the diameter of the piping, by the flow rate of the medium, or by the pressure and temperature of the medium.

### SUMMARY OF THE INVENTION

The aforementioned objective is achieved by a method for physical treatment of liquid and gaseous media by means of electromagnetic emission with a variable frequency of emission which is emitted into a flowing medium from a space inside the medium, according to the invention, whose subject matter consists in that an electromagnetic emission with a specified frequency is generated in the form of electromagnetic pulses and emitted into the medium through an interface made of a silicon-based material, then the electromagnetic emission passes through the medium, and the energy of the generated electromagnetic emission and the energy of the electromagnetic emission passed through the medium are measured, furthermore, the difference of the energy of the generated electromagnetic emission and the energy of the electromagnetic emission passed through the medium is determined, and based on the determined difference of the mentioned energies, the specified frequency of the generated electromagnetic emission is adjusted to increase the difference of the mentioned energies, wherein the steps of the generating electromagnetic emission with a specified frequency, the electromagnetic emission entry into the medium, the passage of the electromagnetic emission through the medium, energy measurement, the determining of energy difference and the adjustment of the specified frequency of the generated electromagnetic emission are repeated until essentially the maximum energy difference is achieved, thus achieving synchronisation of the frequency of the electromagnetic emission with a precession frequency of protons in the medium, and electromagnetic emission energy absorption by the medium.

An advantage of this method is the automatic achievement of the synchronisation of the frequency of electromagnetic emission with the precession frequency of protons in the medium, which can be used for the entire spectrum of electromagnetic emission. In this method, when the electromagnetic emission is emitted into the flowing medium from the space inside the medium and the point of emitting emission is surrounded by the flowing medium, the emission is absorbed by atomic nuclei (excitation) by the action of electromagnetic emission, and the interaction with the dynamics of the medium is an inevitable condition. This can lead to a number of processes: reflection, diffusion, absorption, fluorescence/phosphorescence and photochemical reaction, and changes in the structure of the molecules occur, too. The angle that the hydrogen bridges form changes, forming clusters with higher electron densities, and the atoms begin to assemble into an ordered structure, which is also called a liquid crystal. The wavelength changes due to the passage of electromagnetic emission through the silicon-based material (through the silicon-based material/water (medium) interface). Emission can exist in two forms, both as a wave and as a particle (a photon). By passing of the electromagnetic emission through a silicon-based material, the particles take some of the information from it, resulting in increased absorbance, pH value, and electrical conductivity. Furthermore, the influence on the kinetics of electric bilayer formation is increased, which strengthens: weakening of the binding strength of molecules in the supramolecular structure, weakening of bonds, changes in chemical potential (of water), and changes in electrical equilibrium conditions. The advantage of this method is that it can also be used in large reservoirs, tanks, bodies of water, etc.

Each element and each substance corresponds to a certain frequency/wavelength of the electromagnetic spectrum. By using a certain frequency/wavelength, we can focus on a specific substance in the medium and change it.

The specific value of the frequency of the electromagnetic emission at the beginning of carrying out this method for physical treatment of liquid and gaseous media is set empirically according to the type of medium (e.g. its properties, composition etc.) and according to the required treatment of the medium. The difference between the energy of the generated electromagnetic emission and the energy of the electromagnetic emission passed through the medium has only one peak in the range of the generated frequency of the electromagnetic emission in a graphical interpretation. The maximum energy difference is determined so that the energy difference first increases with gradual changes in the frequency of the generated emission in one direction, and then it begins to decrease. The turning point between increasing and subsequent decreasing of the energy difference corresponds to the maximum energy difference.

According to a preferred embodiment of the method for physical treatment of liquid and gaseous media the frequency of the electromagnetic emission is in the range from 10 Hz to 10¹⁹ Hz. This includes the full range of the electromagnetic emission spectrum, i.e. both ionising and non-ionising emission, for which the mentioned method of treatment of liquid and gaseous media is applicable, and thus includes a large number of applications for the use of this method.

According to a preferred embodiment of the method for physical treatment of liquid and gaseous media the energy of the electromagnetic emission is measured by means of a voltage induced by a magnetic field. It is a simple, reliable, and accurate way to measure the energy of electromagnetic emission.

According to a preferred embodiment of the method for physical treatment of liquid and gaseous media, the energy of electromagnetic emission passed through the medium is measured at the point of the emitting the electromagnetic emission into the medium, where the electromagnetic emission passed through the medium returns after reflection from the wall of a structure containing the medium. This prolongs the trajectory of electromagnetic emission passage through the medium before determining the amount of its energy, and the device for the implementation of this method can be concentrated at one place of installation and not be distributed in multiple places.

According to a preferred embodiment of the method for physical treatment of liquid and gaseous media, the effect of the electromagnetic emission on the medium is enhanced by an external magnetic field acting on the arrangement of randomly distributed protons in the medium. This arranges protons positioned chaotically, amplifies the interference of the waves, makes it easier for pulses of electromagnetic waves to get into resonance with the frequency of proton precession, and the energy is transferred. The external magnetic field may be a field generated by a permanent magnet located on the piping at the location of the treatment of liquid and gaseous media according to this method.

According to a preferred embodiment of the method for physical treatment of liquid and gaseous media, the electromagnetic emission is emitted into the medium from multiple points of the space inside the medium to form a homogeneous electromagnetic field acting on the medium.

This makes it easier for pulses of electromagnetic waves to get into resonance with the frequency of proton precession, and the energy is transferred.

According to a preferred embodiment of the method for physical treatment of liquid and gaseous media, the medium is put into a circular motion around the point to the emitting the electromagnetic emission into the medium. This also acts on the medium hydrodynamically, a strong rotation around the point to the emitting the electromagnetic emission into the medium causes pressure differences, which in conjunction with the reactive field shifts the chemical equilibria, resulting in chemical reactions that would not occur under normal flow conditions.

The appointed objective is also achieved by a device for physical treatment of liquid and gaseous media, which carries out the above-mentioned method for treatment of media according to the invention, the subject matter of which consists in that the device comprises an electromagnetic emission generator with adjustable emission frequency which is connected to an electromagnetic emission emitter, and to which an antenna is connected, situated in a housing of electrically insulating and magnetically permeable silicon-based material, and the antenna is adapted to emit and receive the electromagnetic emission, wherein an electromagnetic emission receiver is arranged to receive the electromagnetic emission, which is connected with the antenna and with an electromagnetic emission analyser to measure the energy of the electromagnetic emission, to which a control unit is connected for determining and adjusting the desired frequency of the generated electromagnetic emission, which is connected to the electromagnetic emission generator. This device enables automatic adjustment of the optimal frequency of electromagnetic emission to achieve synchronisation of the frequency of the electromagnetic emission with the precession frequency of protons in the medium and absorption of the energy of the electromagnetic emission by the medium. The aforementioned device configuration also allows a compact implementation of this device.

According to a preferred embodiment of the device for physical treatment of liquid and gaseous media, the electromagnetic emission generator is adapted to generate emission from the entire electromagnetic spectrum in the range from 10 Hz to 10¹⁹ Hz. This includes the full range of electromagnetic emission spectrum, i.e. both ionising and non-ionising emission, for which the mentioned device for the treatment of liquid and gaseous media is applicable, and thus includes a large number of applications for the use of this device.

An advantage of the device for the treatment of liquid and gaseous media is the possibility of generating both non-ionising and ionising emission using one shared technological part of the device.

According to a preferred embodiment of the device for physical treatment of liquid and gaseous media, the housing is made of a chemically resistant material. This makes it possible to use the device also for such media as acids and alkalis.

According to a preferred embodiment of the device for physical treatment of liquid and gaseous media, the antenna is a helix antenna. A helix antenna is an antenna which has a large bandwidth and is easy to be designed.

According to a preferred embodiment of the device for physical treatment of liquid and gaseous media, the device is arranged in the shape of a probe, wherein the housing has an elongated shape and is hermetically connected to a holder of the housing at one end; a fastening means for hermetic fastening of the device to the structure with the treated liquid or gaseous medium is attached to the holder of the housing, and a head is arranged on the fastening means, comprising the electromagnetic emission generator, the electromagnetic emission emitter, the electromagnetic emission receiver, the electromagnetic emission analyser, and the control unit.

An advantage of this embodiment is that the device is space-saving, that the housing and the holder of the housing, which are in contact with the medium to be treated, do not restrict the flow cross-section of the medium. Furthermore, the length of the housing defines the amount of medium that is in contact with or in close proximity to the housing and is thus precisely adjusted. The device acts on the entire volume of the medium flowing through the piping, thus achieving higher performance. This embodiment allows easy implementation of the device directly into existing technologies with a treated medium.

In a global sense, an undisputed advantage of the present invention is the fact that various properties of water, steam or any other liquid and gaseous media are modified at the molecular level, which does not only save costs in the electricity, heat or cold production, but also contributes significantly to a lower environmental burden with a higher energy efficiency of individual media.

The device is inserted with its part consisting of the housing and the holder of the housing into the medium to be treated. In the case of a medium flowing through the piping, the device is inserted through an opening on the piping, equipped with a pipe coupling and a fastening means. The housing and the holder of the housing, preferably made in the shape of a probe, are immersed in the medium and the antenna placed in the housing acts on this medium by electromagnetic emission in the form of electromagnetic waves and pulses. The effect of the action of energy transmitted by electromagnetic waves is a change in the internal structure of individual atoms and molecules of the medium, which results in a change of its physical properties.

Preferably, the device is inserted into the medium under a certain inclination to the structure (the wall of the piping, tank, reservoir etc.), on which it is mounted. It is generally situated so that it points to the centre of the piping, reservoir, tank etc. This also applies to the use of multiple devices.

Electromagnetic emission interaction occurs between the antenna with the housing and the environment. Thus, the interaction with particles presented in the fluid, and with the walls of metal piping and equipment or with the walls and bottom of tanks, lakes or riverbeds occurs.

The device acts on the entire volume of the medium flowing through the piping, thus achieving higher performance. It is also possible to use more than one device at a time, i.e. at least two devices. This is advantageous, for example, in the case of pipings with large diameters, where the devices according to the present invention are inserted next to each other and/or one after another in the piping in the manner described above. Individual devices can be arranged on the piping, for example, in a circle or in a spiral at a certain distance from each other, thus creating a homogeneous magnetic field in the medium between them, in which pulses of electromagnetic waves get into resonance with the frequency of proton precession more easily and energy transmission occurs, thus increasing their efficiency.

The medium is exposed to the action of a reactive near field which is formed in the immediate vicinity of the antenna with the housing, but there is no direct contact of the medium with the antenna. The electromagnetic wave is not only emitted, but it also contains a reactive component, which means that the nature of the reactive near field around the antenna with the housing is sensitive and responds to EM attenuation in this area caused by absorbing the energy transmitted into the medium. A certain amount of energy is returned to the antenna with the housing and remains in the immediate vicinity of its surface. This energy oscillates back and forth between the antenna with the housing and the field.

By the action of the reactive near field, some protons, arranged in parallel (in a state with a lower energy intensity), obtain the necessary energy and change their arrangement to the opposite one—antiparallel. The result is a reduction, equalization, or even a change in the ratio between the number of protons arranged in parallel and antiparallel and a change in the nature of their precession.

When using, for example, infrared emission with a frequency characteristic for the given hydraulic circuit medium (a certain frequency in the electromagnetic spectrum area in the infrared region), the medium in the reactive near field enters the Energy Harvesting state under certain hydrodynamic conditions, when the process of acquiring free energy from the surrounding environment starts (a form of alternative energy source). After leaving the reactive field, the supply of energy from the antenna is terminated and the protons get rid of excess energy and return to the parallel, less energy-intensive position-they “relax”. An exchange of energy occurs. Thus, energy is gradually transferred to the surroundings.

Thus, there is an increase in energy in the whole medium, which is manifested by a change in the energy state of its atoms or molecules and a change in its physical properties, and chemical changes can also occur in the medium. For example, the number of clusters of hydrogen bridges changes in water, physical properties (evaporation heat, density, melting point, heat capacity, etc.) change and chemical changes of compounds of elements presented in water (salts, oxides, etc.) also occur.

When electromagnetic emission interacts with the medium flowing around the reactive field created by the device, it induces the modification to the structure of the medium, changes its physical properties, and more physical and chemical reactions occur. The emission is partially absorbed, causes chemical reactions, or re-emission of secondary emission, etc. Excitation occurs. The energy is transferred to an atom, an ion, or a molecule, which puts it in a higher energy state, which is called the excited state. After a short time, the excited particle relaxes to its previous or basic state, and the energy is transferred to other atoms or molecules, while the ambient temperature increases. Relaxation can take place by photometric decomposition to form new substances, or by luminescent re-emission of emission.

In principle, it is the action of the modulated electromagnetic signal (frequency transmission of information) and electromagnetic pulses on atoms that excites energy (quantum energy), which causes energy changes in atoms and thus also in molecules (for example, the formation of an electrical bilayer in a supramolecular structure). One of the many consequences of this “action” is ionisation, polarisation, and excitation.

A medium can be any gaseous or liquid medium. Water is the most frequently used medium in technological processes and also the subject of interest in many sectors of the economy. The specific range of energies the medium is exposed to is selected depending on the particular medium used (on its properties, composition, etc.), but also on the desired treatment of the medium. The electromagnetic spectrum used for drinking water is used especially in the area with the wavelength belonging to non-ionising electromagnetic emission (up to 100 nm, which corresponds to the frequency of 4300 kHz). Ionisation of drinking water is often prohibited by regulations. The entire electromagnetic spectrum is used for other liquids. Each element and each substance that makes up the medium has its own precession frequency, and in order to achieve the desired changes, it is necessary to tune the electromagnetic emission to this frequency to get into resonance with it.

The practical use of the present invention is very broad. It can be used both in households and in industries where technical, technological, utility and industrial water, drinking water, and other liquids, are used. Examples include, without limitation, the treatment of drinking water, in which the use of the subject of the present invention prevents the incrustation of distribution pipes, fittings, and all hydraulic equipment (water reservoirs, tanks, boilers), their cleaning-de-incrustation, and the prevention of corrosion. The present invention can also be used to treat domestic hot water (DHW) to increase the energy efficiency of heating, to soften water, to separate and remove undesirable elements, compounds and salts from water, to remove gases; for the treatment of wells and underground water reservoirs with treated water, for the increase of coagulation and sedimentation processes in wastewater treatment plants, reservoirs, lakes, watercourses, seas, and oceans; for the treatment of liquids to increase energy efficiency on the heat exchange surfaces of heating and cooling systems, for the treatment of liquid fuels and air supplied to boilers, internal combustion engines, turbines to improve combustion and thus increase the temperature; for the treatment of exhaust gases in exhaust and flue pipes to reduce emissions; for the treatment of liquids to prevent the multiplication of bacteria, the formation of algae and for disinfection in distribution systems and tanks in industry and natural reservoirs and watercourses; to improve the energy efficiency of the transport of liquids in distribution pipelines; for water treatment for snow-making equipment, for the production and treatment of ice rinks; for the treatment of liquids in the chemical and pharmaceutical industries to increase solubility and to increase catalytic effects; to treat water for laundries, wash rooms to improve energy efficiency, to reduce the amount of detergents used and to reduce water consumption; for water treatment for concrete and plaster in construction industry; in power industry, healthcare, indoor swimming pools, outdoor swimming pools, wellness facilities, agriculture, or animal husbandry.

### OVERVIEW OF FIGURES IN THE DRAWINGS

The present invention will be further described in more details with reference to the drawings, in which:

FIG. 1 shows a flow chart of the method for physical treatment of liquid and gaseous media according to claim 1.

FIG. 2 shows a schematic illustration of the functional parts of the device according to the invention and their interconnection.

FIG. 3 shows an external view of the device according to the invention.

FIG. 4 shows an illustration of the implementation of the device of FIG. 3 in a straight pipeline.

FIG. 5 shows an illustration of the implementation of the device of FIG. 3 in a curved piping or to the elbow of the piping.

FIG. 6 shows a schematic illustration of a vortex chamber complemented with the device according to the invention.

FIG. 7 shows an implementation of the plurality of devices of FIG. 3 side by side in a circle on a large diameter piping in a cross-sectional view of the piping.

FIG. 8 shows an implementation of the plurality of devices of FIG. 3 side by side in a circle on a large diameter piping in a longitudinal sectional view of a part of the piping.

### EXAMPLES OF EMBODIMENTS OF THE INVENTION

The present examples serve for illustration and better understanding of the invention, and they are in no way to be construed as limiting the scope of the invention.

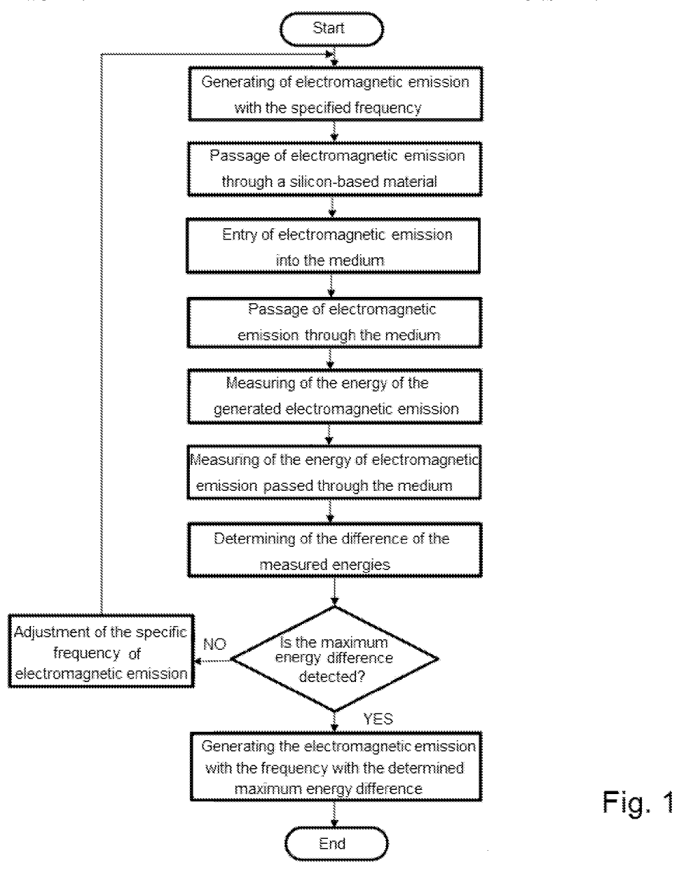

FIG. 1 shows a flow chart of the method for physical treatment of liquid and gaseous media according to claim 1. The medium 15 being treated is water and it is required to adjust its physical properties, in particular density (kg/m³), melting temperature (J/g), heat of vaporisation (J/g) and heat capacity cₚ (J/(g° C.)). The medium 15 flows in the piping 13. In the “generating of electromagnetic emission of a specified frequency” step, in the electromagnetic emission generator 1 is generated the electromagnetic emission of a specified frequency, which is selected according to the medium 15 to be treated and to the desired medium 15 treatment. For the medium 15 water and for adjusting of the physical properties of the medium 15 mentioned above, the specified frequency of electromagnetic emission at the beginning of the process is set to 430 MHz. Electromagnetic emission is in the form of pulses symmetrical about zero amplitude, the pulses have the shape of a narrow trapezoid which is wider at zero amplitude and narrower at the peak amplitude, and the amplitude of pulses has a size of 120 dBμV and the width of pulse is 2 ns. Electromagnetic emission is emitted to the medium 15 by the antenna 4. In the “passage of electromagnetic emission through the silicon-based material” step, before entering the medium 15, the electromagnetic emission first passes through the housing 5 made of glass. In the “entry of electromagnetic emission into the medium” step, the electromagnetic emission enters the medium 15 to be treated. In the “passage of electromagnetic emission through the medium” step, the electromagnetic emission passes through the medium 15, reflects from the wall of the piping 13 and returns to the antenna 4. The antenna 4 receives the signal passed through the medium 15 and sends it to the electromagnetic emission analyser 6. In the “measuring of the energy of the generated electromagnetic emission” step, the energy of the currently generated emission is measured. This measurement is performed in the control unit 7 by measuring the voltage induced by the magnetic field of the emission. In the “measuring of the energy of the electromagnetic emission passed through the medium” step, this energy is again measured by measuring the voltage induced by the magnetic field of the emission, this time in the electromagnetic emission analyser 6. Both measured energy values are sent to the control unit 7, where the difference of the measured energies is calculated in the “determining of the difference of the measured energies” step. The task of the control unit 7, among other things, is to set the value of the frequency of the generated electromagnetic emission so that the difference of the measured energies is maximum. The frequency setpoint is sent from the control unit 7 to the electromagnetic emission generator 1, which generates emission with the desired frequency.

The algorithm for finding the maximum energy difference is implemented using the “is the maximum energy difference detected?” step. If the maximum energy difference is not detected, then a new frequency value will be set in the “adjustment of the specific frequency of electromagnetic emission” step, it will be sent to the electromagnetic emission generator 1, and the steps above are repeated. The graphical line of the energy difference has one peak, i.e. one maximum value that needs to be identified. If the energy difference decreases when changing the frequency of electromagnetic emission in one direction (e.g. when decreasing the frequency), it is necessary to change the frequency in the other direction (increase the frequency). If the energy difference increases when changing the frequency of electromagnetic emission in one direction (e.g. when decreasing the frequency), it continues to change the frequency in this direction. The change in frequency takes place until the energy difference begins to decrease again after its growth. The searched frequency at which the frequency of the electromagnetic emission is synchronised with the precession frequency of the protons in the medium is thus the value of the frequency set before the cycle in which the energy difference began to decrease after the previous growth.

After finding the frequency at which the frequency of the electromagnetic emission is synchronised with the precession frequency of the protons in the medium, this value of the specified frequency is sent to the electromagnetic emission generator 1 and electromagnetic emission with this frequency is further generated.

The following changes in water properties were achieved by the above physical water treatment: density changed from the original value of 998.292 kg/m³ to the value of 998.220 kg/m³, melting temperature changed from the original value of 317 J/g to the value of 325 J/g, heat of vaporisation changed from the original value of 1925 J/g to value of 2090 J/g and heat capacity cₚ changed from the original value of 4.67 J/(g° C.) to value of 4.15 J/(g° C.). Water treated in this way can be used in households, in all areas of industry, in agriculture, animal husbandry, and its advantage over untreated water is that it is structured, it streamlines the production processes with regard to the environmental impact and energy efficiency, wherever water is used, it improves heating, cooling, evaporation, condensation, absorption, coagulation, filtration, and electricity production in steam turbines processes, it prevents the formation of lime-scale and corrosion, it cleans hydraulic systems, reduces or completely eliminates the use of chemical agents to treat all types of water, it improves the solubility of substances in water, and improves cell nutrition.

According to another example of the embodiment, the treated medium 15 is a gaseous medium, in particular water steam, and there is a requirement to adjust its physical properties, in particular density (kg/m³), enthalpy (KJ/kg), entropy (KJ/kg·K). For the medium 15 water steam and for adjusting its physical properties mentioned above, the specified frequency of electromagnetic emission at the beginning of the process is set to 430 MHz. Electromagnetic emission is in the form of pulses symmetrical about zero amplitude, the pulses have the shape of a narrow trapezoid which is wider at zero amplitude and narrower at the peak of amplitude, and the amplitude of pulses has a size of 24 dbm and the width of pulse is 2 ns. The following changes in the properties of steam at temperature of 250° C. and pressure of 3.98 MPa were achieved by the above-mentioned method for physical steam treatment: density changed from the original value of 19.98 kg/m³ to the value of 20.12 kg/m³, enthalpy changed from the original value of 2800.97 kJ/kg to the value of 3151.091 KJ/kg, entropy changed from the original value of 6.072 KJ/kg·K to the value of 6.539 KJ/kg·K. The steam treated in this way can be used in electricity and heat production, in industry wherever it is used directly in technological processes, and its advantage over untreated steam is that its production consumes less energy, it transfers more energy in itself, increases the performance of heating systems and turbines, and reduces energy degradation (increase in entropy) in processes.

Steam treatment in a thermal power plant with steam boilers with a total installed capacity of 85 MW and one back-pressure turbine with a power of 6 MW (the amount of electric power generated is 25,219 MWh/year, the amount of heat produced 940,199 GJ/year) resulted in a relative increase in heat generation efficiency by 2.6%, a relative increase in electric power production efficiency by 16% and an overall reduction in input energy by 11%.

The method for physical treatment of media according to the present invention makes it possible to modify a very wide range of hydrocarbons, the interaction of which is necessary to achieve the polarity required to increase the “flash point”. For example, restructuring occurs in natural gas. A new molecular arrangement is created that changes the properties of the gas with more efficient mixing with oxygen, increases the flash point, increases the cetane value, thereby shortening the fuel ignition delay, and increases oxidative exothermic reactions. Usually unburnt carbon emissions are consumed in this case and increase energy at the output and, at the same time, reduce pollutants in the flue gas. Natural gas is then able to produce by 7% more heat with much less by-products—by 60% less emissions.

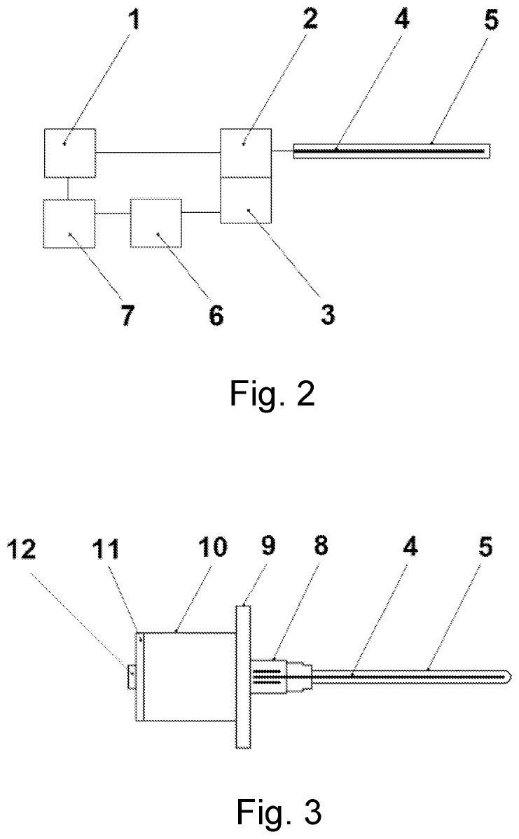

FIG. 2 schematically shows the functional parts of the device for physical treatment of the medium and their interconnection. Electromagnetic emission is generated in the electromagnetic emission generator 1. The frequency of the electromagnetic emission is adjustable and the frequency setpoint is sent to the electromagnetic emission generator 1 from the control unit 7. The electromagnetic emission generator 1 is a generator specifically manufactured for this application, type G400, PIC16F690—Microcontrollers and Processors. The control unit 7 consists of a PIC16F690 processor and a FLASH memory with size of 4 Mbit. The electromagnetic emission generator 1 is connected to an electromagnetic emission emitter 2, which is of the “wobbling frequency” type. The electromagnetic emission emitter 2 is connected to the antenna 4. It is the helix antenna with gain of 20 dBd. The antenna 4 is situated in a housing 5 made of glass. The antenna 4 is used both for emitting of the generated electromagnetic emission into the medium 15 and for receiving of the electromagnetic emission passed through the medium 15. The electromagnetic emission passed through the medium 15 is transmitted from the antenna 4 to the electromagnetic emission receiver 3 connected to the antenna 4, and subsequently to the electromagnetic emission analyser 6. In the electromagnetic emission analyser 6, the energy of electromagnetic emission is measured by means of a voltage induced by the magnetic field of the emission. The electromagnetic emission receiver 3 is of the XTR-434 radio frequency receiver type. The electromagnetic emission analyser 6 comprises a PIC16F690 processor. The electromagnetic emission analyser 6 is connected to the control unit 7. The power supply of this device (not shown in FIG. 2) is 12 V DC. The length of the housing 5 defines the amount of medium 15 that is in contact with or in close proximity to the housing 5 and is thus precisely adjusted. The length of housing 5, e.g. for a DN300 piping, is usually 200 mm.

FIG. 3 shows an external view of an example of embodiment of the device according to the invention. The device comprises the head 10, on which the fastening means 9 is mounted for fastening the device to the structure with the medium 15 to be treated, e.g. to the piping 13 (not shown in FIG. 3). The fastening means 9 is a flange. The flange mounting allows a quick, reliable and tight connection of the device to the piping 13, vessel or other structure with the medium 15 to be treated. The holder 8 of the housing 5 is connected to the fastening means 9, holding the housing 5, in which the antenna 4 is situated. The housing 5 is hermetically sealed with elastomers and sealants at the holder 8 of the housing 5. This ensures a safe hermetic separation of the inside of the housing 5 and the holder 8 of housing from the measured medium 15 and prevents leakage of the measured medium 15 from the piping 13, vessel or other structure through the mounting hole of the treatment device of the medium 15. The housing 5 is made of glass, which is electro-insulating, magnetically permeable and chemically resistant material. In another embodiment, the housing 5 can be made e.g. of ceramics. The antenna 4 is a helix antenna made of a conductor. The conductor is fixed in the fastening means 9 by a ceramic bushing (not shown) sealed with elastomers and sealants. The electromagnetic emission generator 1, the electromagnetic emission emitter 2, the electromagnetic emission receiver 3, the electromagnetic emission analyser 6 and the control unit 7 are arranged in the head 10 (not shown in FIG. 3). The head 10 is hermetically sealed. The head 10 comprises a lid 11, on which a power supply connector 12 is arranged for connecting the power supply of the device. The power supply of the device is 230 V, 50 Hz. In another embodiment of the invention, the power supply can be 12 V DC. The power supply connector is equipped with an optical signalling to indicate the presence of power supply.

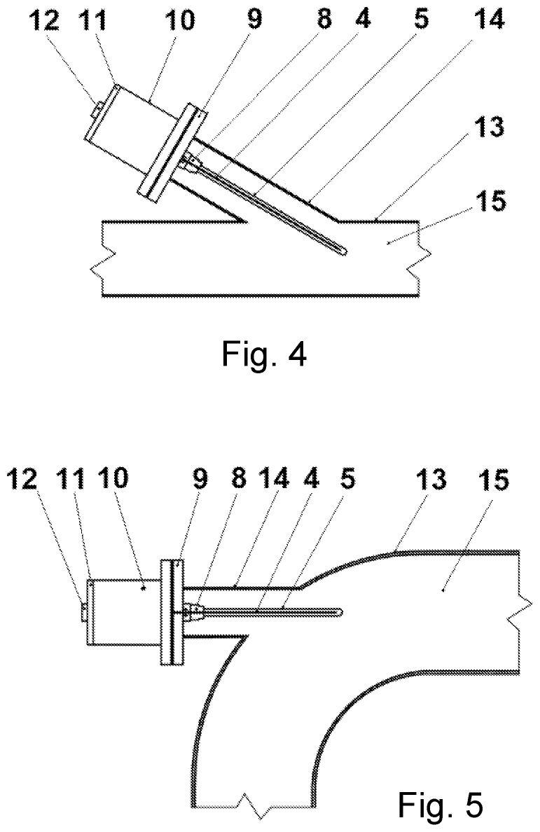

FIGS. 4 and 5 show the installation of the device of FIG. 3 in the pipeline 13. In FIG. 4, the device is installed in a straight pipeline 13, in FIG. 5, it is installed in an elbow of the piping 13. The medium 15 to be treated flows in the piping 13. The pipe coupling 14 is installed on the piping 13 for fixing the device to the piping 13. The pipe coupling 14 comprises a counterpart to the fastening means 9, the counterpart being a counter-flange. The device is inserted by the housing 5 into the pipe coupling 14 and fastened by the fastening means 9 to the counterpart installed on the pipe coupling 14. After installation, the housing 5 with the antenna 4 is installed inside the piping 13, they extend into the piping 13 and the flowing medium flows around the housing 5. The medium 15, which is thus in contact with the housing 5, is exposed to an action of a reactive near field formed in the immediate vicinity of the antenna 4 with the housing 5. The head 10 is installed at the end of the pipe coupling 14 and does not come into contact with the medium 15. When the device is implemented in a straight pipeline 13 as seen in FIG. 4, or into an elbow of the piping 13 as seen in FIG. 5, the housing 5 with the antenna 4 is inserted into the piping 13 at an angle to the piping 13 in the case of the straight pipeline 13, or in a direction parallel to the axis of the piping 13 in the case of the elbow of the piping 13 through the pipe coupling 14 downstream, and it is fastened to it with the fastening means 9.

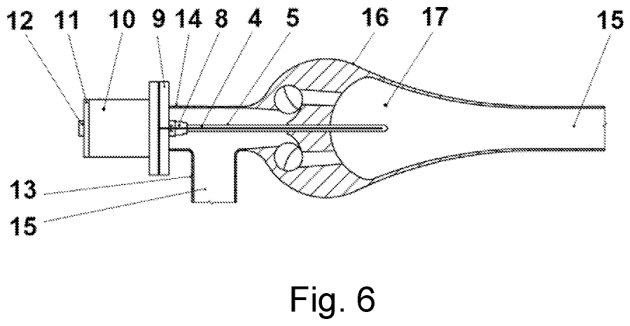

The solution shown in FIG. 6 presents a method for putting the medium 15 in a circular motion around the housing 5 by means of a vortex generator 16. This is a solution which consists in supplementing the vortex chamber 17 with the device according to the invention. As a result, the medium 15 flowing through the piping 13 will act hydrodynamically, in addition to electromagnetic emission. The medium 15 gets into a heavy rotation, which creates pressure differences-pressure and negative pressure. A strong pressure gradient in conjunction with a reactive field shifts chemical equilibria, resulting in chemical reactions that would not occur under normal flow conditions.

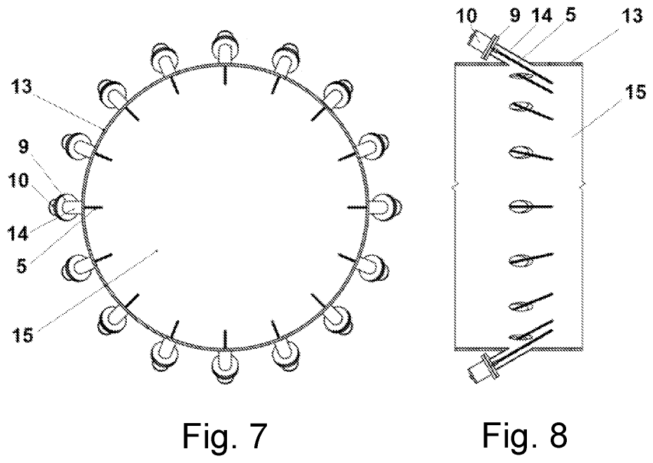

It is possible to insert multiple devices in a series at a small distance into the piping 13, opposite each other on a straight pipeline, and/or next to one another at a certain distance. FIGS. 7 and 8 show a method for generating a homogeneous magnetic field by installing multiple devices. The installation of multiple devices is used e.g. for the piping 13 of large diameters, e.g. from size DN300. The devices in FIGS. 7 and 8 are installed in a circle as shown in FIG. 7 in the cross-section and in FIG. 8 in longitudinal section through the piping 13. The devices can also be placed in a spiral. The ends of the housings 5 face the centre of the piping 13. When installing multiple devices, a homogeneous magnetic field is created among them, thus increasing their efficiency.

### LIST OF REFERENCE NUMBERS

1 electromagnetic emission generator
2 electromagnetic emission emitter
3 electromagnetic emission receiver
4 antenna
5 housing
6 electromagnetic emission analyser
7 control unit
8 holder of housing
9 fastening means
10 head
11 lid
12 connector
13 piping
14 pipe coupling
15 medium
16 vortex generator
17 vortex chamber

1. A method for physical treatment of liquid and gaseous media (15) by means of electromagnetic emission with a variable frequency of emission which is emitted into a flowing medium (15) from a space inside the medium (15), characterised in that an electromagnetic emission with a specified frequency is generated in the form of electromagnetic pulses and it is emitted into the medium (15) through an interface made of a silicon-based material, then the electromagnetic emission passes through the medium (15), and the energy of the generated electromagnetic emission and the energy of the electromagnetic emission passed through the medium (15) are measured, furthermore, the difference of the energy of the generated electromagnetic emission and the energy of the electromagnetic emission passed through the medium (15) is determined, and based on the determined difference of the said energies, the specified frequency of the generated electromagnetic emission is adjusted to increase the difference of the said energies, wherein the steps of the generating electromagnetic emission with a specified frequency, the electromagnetic emission entry into the medium (15), the passage of the electromagnetic emission through the medium (15), energy measurement, the determining of energy difference and the adjustment of the specified frequency of the generated electromagnetic emission are repeated until essentially the maximum energy difference is achieved, thus achieving synchronisation of the frequency of the electromagnetic emission with a precession frequency of protons in the medium (15) and electromagnetic emission energy absorption by the medium (15).

2. The method for physical treatment of liquid and gaseous media (15) according to claim 1, characterised in that the frequency of the electromagnetic emission is in the range from 10 Hz to 10¹⁹ Hz.

3. The method for physical treatment of liquid and gaseous media (15) according to any one of claims 1 through 2, characterised in that the energy of the electromagnetic emission is measured by means of a voltage induced by a magnetic field.

4. The method for physical treatment of liquid and gaseous media (15) according to any one of claims 1 through 3, characterised in that the energy of the electromagnetic emission passed through the medium (15) is measured at the point of the emitting the electromagnetic emission into the medium (15), where the electromagnetic emission passed through the medium returns after reflection from the wall of a structure containing the medium (15).

5. The method for physical treatment of liquid and gaseous media (15) according to any one of claims 1 through 4, characterised in that the effect of the electromagnetic emission on the medium (15) is enhanced by an external magnetic field acting on the arrangement of randomly distributed protons in the medium (15).

6. The method for physical treatment of liquid and gaseous media (15) according to any one of claims 1 through 5, characterised in that the electromagnetic emission is emitted into the medium (15) from multiple points of the space inside the medium to form a homogeneous electromagnetic field acting on the medium (15).

7. The method for physical treatment of liquid and gaseous media (15) according to any one of claims 1 through 6, characterised in that the medium (15) is put into a circulating motion around the point of the emitting the electromagnetic emission into the medium (15).

8. A device for physical treatment of liquid and gaseous media (15) using the method according to claims 1 to 7, characterised in that it comprises an electromagnetic emission generator (1) with adjustable emission frequency, which is connected to an electromagnetic emission emitter (2), and to which an antenna (4) is connected, placed in a housing (5) made of electrically insulating and magnetically permeable silicon-based material, and the antenna (4) is adapted to emit and receive the electromagnetic emission, wherein an electromagnetic emission receiver (3) is arranged to receive the electromagnetic emission, which is connected with the antenna (4) and with an electromagnetic emission analyser (6) to measure the energy of the electromagnetic emission, to which a control unit (7) is connected for determining and adjusting the desired frequency of the generated electromagnetic emission, which is connected to the electromagnetic emission generator (1).

9. The device for physical treatment of liquid and gaseous media (15) according to claim 8, characterised in that the electromagnetic emission generator (1) is adapted to generate emission from the entire electromagnetic spectrum in the range from 10 Hz to 10¹⁹ Hz.

10. The device for physical treatment of liquid and gaseous media (15) according to claim 8 or 9, characterised in that the housing (5) is made of a chemically resistant material.

11. The device for physical treatment of liquid and gaseous media (15) according to any one of claims 8 to 10, characterised in that the antenna (4) is a helix antenna.

12. The device for physical treatment of liquid and gaseous media (15) according to any one of claims 8 to 11, characterised in that the device is arranged in the shape of a probe, wherein the housing (5) has an elongated shape and is hermetically connected to a housing (5) holder (8) at one end; a fastening means (9) for hermetic fastening of the device to the structure with the treated liquid or gaseous medium (15) is attached to the housing (5) holder (8), and a head (10) is arranged on the fastening means (9), comprising the electromagnetic emission generator (1), the electromagnetic emission emitter (2), the electromagnetic emission receiver (3), the electromagnetic emission analyser (6), and the control unit (7).
